(19) United States
(12) Patent Application Publication
(10) Pub. No.: US 2026/0233682 A1
(43) Pub. Date: Aug. 13, 2026

(54) DEVICE AND METHOD FOR TRANSPORTING LADDERS

(71) Applicant: Elifelet Hernandez, Kyle, TX (US)

(72) Inventor: Elifelet Hernandez, Kyle, TX (US)

(21) Appl. No.: 19/051,605

(22) Filed: Feb. 12, 2025

(51) Int. Cl. B60R 9/048

(52) U.S. Cl. CPC B60R 9/0485

(57) ABSTRACT

The present disclosure relates to a system for transporting a ladder on a truck, the truck including a tailgate top surface, a tailgate inner surface, a cargo bed, and a cabin surface positioned higher than the tailgate top surface, and a strap. In particular the system includes a first swing anchor foot configured to pivotally attach to the ladder and to rotate relative to the ladder into a plurality of lockable positions and into engagement with the tailgate inner surface, and configured such that a force applied by the strap pulls the ladder into frictional engagement with the tailgate top surface and the cabin surface.

### BACKGROUND

This section is intended to provide relevant contextual information to facilitate a better understanding of the various aspects of the described embodiments. Accordingly, it should be understood that these statements are to be read in this light and not as admissions of prior art.

The present invention relates to devices and methods for transporting ladders affixed to the cargo area of passenger pickup truck vehicles, and particularly to the transport of relatively long ladders such as those used by professional tradesmen. Many current solutions require the pickup truck to be retrofitted with rack systems that are permanently and rigidly connected to the cargo bed or to other portions of the truck. However, such rack systems are expensive to purchase and install and can be in the way when other types of loads need to be loaded into or carried within the cargo area. For example, the placement of such ladder racks often prevents a forklift from reaching over the edges of the cargo area and lowering a heavy load. In another example, such ladder racks are physically in the way of the articulating motion of a front-end-loader when aggregate or dirt is transferring into the cargo area. Accordingly, there is a need for a system and method to effectively secure a ladder (particularly long commercial ladders) to the cargo bed of a pickup truck that does not require specialty racks to be mounted to the pickup truck, and thus preserves the flexible of the cargo area for many other types of loads.

### SUMMARY

To meet the needs described above and others, the present disclosure provides systems and methods for securing ladders in the cargo bed of a passenger vehicle. The system includes a first swing anchor foot configured to pivotally attach to the ladder and to rotate relative to the ladder into a plurality of lockable positions and into engagement with the tailgate inner surface, and configured such that a force applied by the strap pulls the ladder into frictional engagement with the tailgate top surface and the cabin surface.

In accordance with a second aspect of the present disclosure, which may be used in combination with any other aspect listed herein unless stated otherwise, the system, wherein the first swing anchor foot is further configured such that the force applied by the strap also pulls the first swing anchor foot into frictional engagement with the tailgate inner surface.

In accordance with a third aspect of the present disclosure, which may be used in combination with any other aspect listed herein unless stated otherwise, the system, further including a second swing anchor foot that is pivotally attached to the ladder and is configured such that rotation of the second swing anchor foot relative to the ladder will bring the second swing anchor foot into frictional engagement with the tailgate inner surface, and wherein the second swing anchor foot is rotatable and lockable independent of the first swing anchor foot.

In accordance with a fourth aspect of the present disclosure, which may be used in combination with any other aspect listed herein unless stated otherwise, the system, wherein the first swing anchor foot and the second swing anchor foot are configured to rotate along a pivot axis that passes through a rung cavity of the ladder.

In accordance with a fifth aspect of the present disclosure, which may be used in combination with any other aspect listed herein unless stated otherwise, the system, further including a first slidable base and a second slidable base which are bolted together by a tie rod that passes through the rung cavity of the ladder, wherein the first slidable base and second slidable base are selectably positionable along a plurality of locations along the ladder.

In accordance with a sixth aspect of the present disclosure, which may be used in combination with any other aspect listed herein unless stated otherwise, the system, wherein the first swing anchor foot further includes a pivot shoe that is configured to contact the tailgate inner surface, wherein the pivot shoe is rotatable relative to the first swing anchor foot along a shoe pivot axis that is offset from and parallel to the pivot axis.

In accordance with a seventh aspect of the present disclosure, which may be used in combination with any other aspect listed herein unless stated otherwise, the system, wherein the pivot shoe is rotationally lockable along the shoe pivot axis.

In accordance with an eighth aspect of the present disclosure, which may be used in combination with any other aspect listed herein unless stated otherwise, the system, wherein the first swing anchor foot further includes a pin and the first slidable base further includes a plurality of detents arranged circumferentially around the pivot axis, wherein the first swing anchor foot is configured to rotate along the pivot axis and lock into a fixed angular position relative to the first slidable base when the pin engages with one of the plurality of detents.

In accordance with a ninth aspect of the present disclosure, which may be used in combination with any other aspect listed herein unless stated otherwise, the system, further including a spring concentrically mounted on a post and along the pivot axis and configured to be positioned within the rung cavity of the ladder when the first slidable base and the second slidable base are bolted together, and wherein compression from the spring acts to maintain engagement between the pin and one of the plurality of detents.

In accordance with a tenth aspect of the present disclosure, which may be used in combination with any other aspect listed herein unless stated otherwise, the system, wherein the first swing anchor foot further includes a first washer and the first slidable base further includes a second washer concentrically positioned along the pivot axis, wherein the first swing anchor foot is configured to rotate along the pivot axis and lock into a fixed angular position relative to the first slidable base when the first washer engages with the second washer.

In accordance with an eleventh aspect of the present disclosure, a method for transporting a ladder, the method including placing the ladder along a tailgate top surface and a cabin surface positioned higher than the tailgate top surface; attaching a swing anchor assembly to the ladder, wherein the swing anchor assembly has a first swing anchor foot; rotating the first swing anchor foot relative to the ladder and into engagement with the tailgate inner surface; locking the first swing anchor foot rotated position; and applying a force with a strap to secure the ladder against the tailgate top surface and the cabin surface.

In accordance with a twelfth aspect of the present disclosure, which may be used in combination with any other aspect listed herein unless stated otherwise, the method, wherein applying the force with the strap also pulls the first swing anchor foot into frictional engagement with the tailgate inner surface.

In accordance with a thirteenth aspect of the present disclosure, which may be used in combination with any other aspect listed herein unless stated otherwise, the method, wherein the first swing anchor foot further includes a pivot shoe, that is rotatable relative to the first swing anchor foot along a shoe pivot axis that is offset from and parallel to the pivot axis, the method further including rotating the first swing anchor foot into engagement with the tailgate inner surface.

In accordance with a fourteenth aspect of the present disclosure, which may be used in combination with any other aspect listed herein unless stated otherwise, the method, wherein the swing anchor assembly further includes a second swing anchor foot, the method further including rotating the second swing anchor foot relative to the ladder and into engagement with the tailgate inner surface; and locking the second swing anchor foot rotated position.

In accordance with a fifteenth aspect of the present disclosure, which may be used in combination with any other aspect listed herein unless stated otherwise, the method, wherein the rotating of the first swing anchor foot and the second swing anchor foot occurs along a pivot axis that passes through a rung cavity of the ladder, and wherein the attaching of the swing anchor assembly to the ladder includes passing a tie rod through the rung cavity of the ladder; and tightening the tie rod to secure a first slidable base and a second slidable base to the ladder.

In accordance with a sixteenth aspect of the present disclosure, which may be used in combination with any other aspect listed herein unless stated otherwise, the method, wherein the rotating of the first swing anchor foot moves a pin relative to the pivot axis and wherein the locking of the first swing anchor foot includes engaging the pin with one of a plurality of detents on the first slidable base.

In accordance with a seventeenth aspect of the present disclosure, which may be used in combination with any other aspect listed herein unless stated otherwise, the method, wherein the swing anchor assembly further includes a spring concentrically mounted on a post and along the pivot axis, and wherein the attaching of the swing anchor assembly includes positioning the spring and the post within the rung cavity of the ladder, and wherein the locking of the first swing anchor foot includes the spring compressively engaging the pin into one of the plurality of detents.

In accordance with an eighteenth aspect of the present disclosure, a ladder including a system for transporting the ladder on a truck, the truck including a tailgate top surface, a tailgate inner surface, a cargo bed, and a cabin surface positioned higher than the tailgate top surface, and a strap, the system including a first swing anchor foot configured to pivotally attach to the ladder and to rotate relative to the ladder into a plurality of lockable positions and into engagement with the tailgate inner surface, and configured such that a force applied by the strap pulls the ladder into frictional engagement with the tailgate top surface and the cabin surface.

In accordance with a nineteenth aspect of the present disclosure, which may be used in combination with any other aspect listed herein unless stated otherwise, the ladder, further including a second swing anchor foot that is pivotally attached to the ladder and is configured such that rotation of the second swing anchor foot relative to the ladder will bring the second swing anchor foot into frictional engagement with the tailgate inner surface, and wherein the second swing anchor foot is rotatable and lockable independent of the first swing anchor foot.

In accordance with a twentieth aspect of the present disclosure, which may be used in combination with any other aspect listed herein unless stated otherwise, the ladder, wherein the first swing anchor foot and second swing anchor foot are configured to rotate along a pivot axis that passes through a rung cavity of the ladder.

By providing a system that is secured to the ladder 16 and moves between lockable positions, the system can quickly adapt to a variety of different ladder 16 transportation angles (as established by cargo bed 4 length and relative heights of cabin surface 22 and tailgate top surface 20) and can quickly transition between a “transportation mode” and a retracted or “inoperable mode” that allows the ladder 16 to be used for climbing without removing the system.

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

Illustrative embodiments of the present disclosure are described in detail below with reference to the attached drawing figures, which are incorporated by reference herein and wherein:

FIG. 1 is an isometric view of a system for affixing a ladder to the cargo area of a pickup truck in accordance with the present disclosure;

FIGS. 2 and 3 are isometric views of a swing anchor assembly from the system of FIG. 1, affixed to the ladder;

FIG. 4 is an isometric view of the swing anchor of FIGS. 2 and 3, in a forward rotated position;

FIG. 5 is an isometric view of the swing anchor of FIGS. 2 and 3, in a rearward rotated position;

FIG. 6 is an isometric view of two swing anchor assemblies, separated from the ladder;

FIG. 7 is a partial cross-sectional schematic view, along pivot axis 15, of a swing anchor assembly, according to one embodiment of the present disclosure;

FIG. 8 is an isometric view of the assembly of FIG. 7 showing the inner anti-rotation features;

FIG. 9 is a partial cross-sectional schematic view, along pivot axis 15, of a swing anchor assembly, according to another embodiment of the present disclosure; and

FIG. 10 is an isometric view of a system for affixing a ladder to the cargo area of a pickup truck, according to another embodiment of the present disclosure.

### DETAILED DESCRIPTION

One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

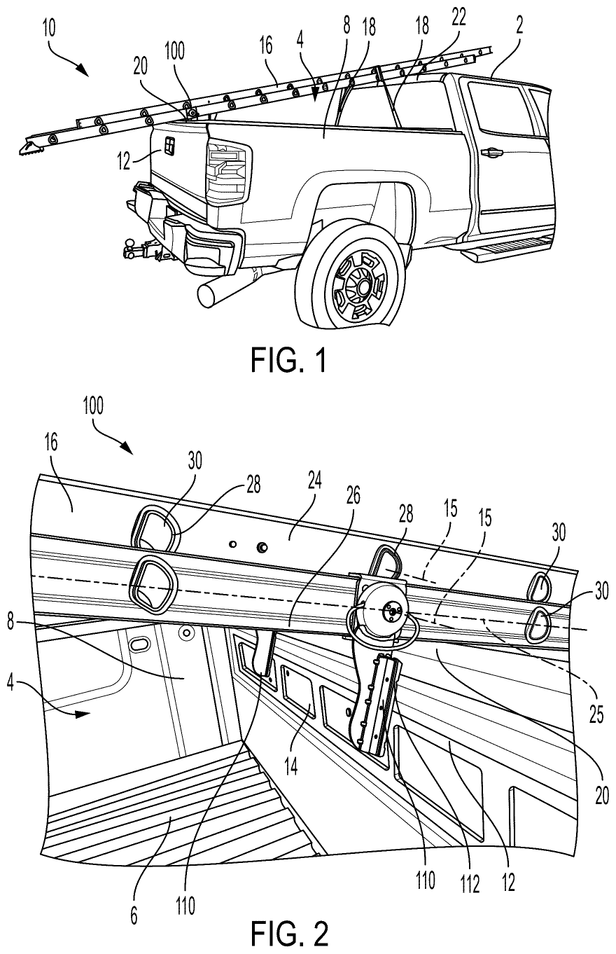

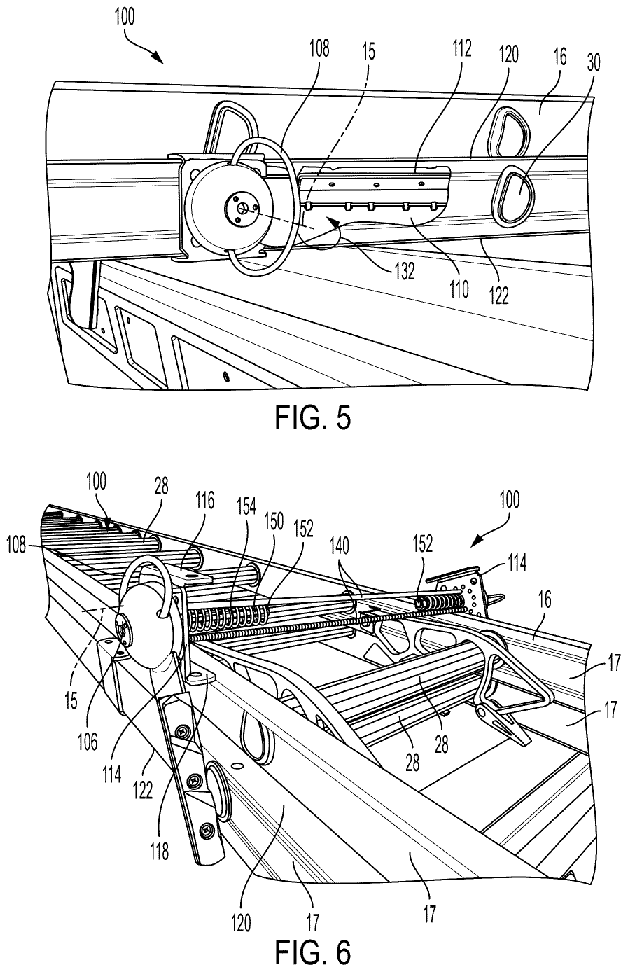

Referring to FIG. 1, Passenger vehicles 10 having an enclosed passenger cabin 2 and a back end mounted cargo bed 4 are commonly referred to as “pick-up trucks”. The cargo bed 4 on many commercially available passenger vehicles 10 are comprised of a horizontally oriented loading floor 6 (FIG. 2), a rear facing portion of the enclosed passenger cabin 2, two parallel side walls 8 extending rearwardly out from the passenger cabin 2, and a hinged tailgate 12 that connects between two rear portions of the side walls 8. Together, the cargo bed 4 is designed to safely transport objects of certain dimensions that can be contained within the confines of the cargo bed 4, or that can be rested within the cargo bed 4 while certain portions overhand the perimeter of the cargo bed 4. For example, when carrying items that are larger than the cargo bed 4, the tailgate 12 may be opened and rotated about its mounting hinge so that a tailgate inner surface 14 (shown in FIG. 2) lays horizontally and in the same plane as the loading floor 6. When the tailgate 12 is laid flat in this manner, both the tailgate 12 and the loading floor 6 may be used to support objects for transport and the effective size of the cargo bed 4 is slightly extended. Relatively long objects such as ladders 16 may be transported in this manner and portions of the ladder 16 may even overhang the rear perimeter of cargo bed 4 area formed by the lowered tailgate 12. When a ladder 16 extends past the end of the lowered tailgate 12, the length of acceptable overhang is limited by many factors such as a safe overall length of the passenger vehicle 10, the security of the ladder 16 as its center of gravity extends to or past the end of the tailgate 12, and transportation laws. In general, the greater the length of tailgate 12 overhang, the less secure the ladder 16 becomes, and the greater the need for straps 18 and/or ropes to secure the ladder 16 to the cargo bed 4. In addition, very long ladders 16, such as those used by professional tradesmen, can be much longer than what can be safely laid flat within the cargo bed 4 in the manner described. In such situations, the tailgate 12 is normally closed, and the ladder 16 is laid across a tailgate top surface 20 and a raised cabin surface 22, positioned higher than the tailgate top surface 20 and proximate to the roof of the enclosed passenger cabin 2. Without limitation, the raised cabin surface 22 maybe the roof of the enclosed passenger cabin 2, or a rack positioned on or near the roof of the enclosed passenger cabin 2. When transporting a ladder 16 in this manner, portions of the ladder 16 extend forward over the enclosed passenger cabin 2, and also extend reward past the end of the tailgate 12. In this configuration, the overall length of the passenger vehicle 10 and ladder 16 is reduced. In addition, the center of gravity of the ladder 16 is better balanced over the cargo bed 4. However, in this position, the security of the ladder 16 is greatly reduced as the ladder 16 is prone to shifting (back and forth as well as front and back) during transport. For example, gravity and driving accelerations tend to shift the ladder 16 in the rearward direction, driving stopping forces tend to shift the ladder 16 in the forward direction, and road vibrations and turning forces tend to shift the ladder 16 in the left or right directions. Straps 18 and/or ropes must be applied to the ladder 16 in at least 4 different directions to counteract the 4 directions of applied forces, however even careful rigging is prone to loosening under repeated loadings and is time consuming to perform each time the ladder 16 is loaded onto the passenger vehicle 10. Therefore, there is a need for a system and method to effectively secure the ladder 16 to the cargo bed 4 of a passenger vehicle 10, and particularly one that provides an easy-to-use system that can reliably secure very long and heavy commercial ladders 16. An embodiment of one such system, according to the present disclosure, is shown as swing anchor assembly 100. In FIG. 1, just a portion of the swing anchor assembly 100 is shown, as some portions of the swing anchor assembly 100 are positioned within portions of the ladder 16, while other portions are positioned within the cargo bed 4. The swing anchor assembly system 100 includes one or more swing anchor feet 110 (shown in FIG. 2), each swing anchor foot 110 attached to the ladder 16 carried by the truck 10, and a strap 18. In FIG. 1, the ladder 16 spans the cabin surface 22 and the tailgate surface 20 and is held in position due to the swing anchor feet 110 (shown in FIG. 2) and the strap 18. The swing anchor foot 110 moves between an operable mode or deployed position, as shown during use in FIG. 2, and an inoperable or retracted mode or position, as shown in FIGS. 4 and 5.

Referring to FIG. 2, the swing anchor assembly 100 interfaces with an inner portion of the cargo bed 4 while the ladder 16 is being transported during use. Swing anchor assembly 100 is shown rigidly mounted to a portion of the ladder 16 and is deployed in a “transportation mode”, whereby a swing anchor foot 110 is rotated outward from the ladder 16 and locked in an operable position to contact and frictionally engage with the tailgate inner surface 14. In the embodiment shown in FIG. 2, the swing anchor foot 110 also includes an integrated pad 112, having a rubber interface. The pad 112 increases the contact area of the swing anchor foot 110, increases the frictional coefficient against the tailgate inner surface 14, and protects contacted surfaces from scratches or damage. While the pad 112, and underlying swing anchor foot 110, in the embodiment of FIG. 2 are shown as having a generally flat surface where the tailgate inner surface 14 is contacted, a curved pad 112, and/or underlying swing anchor foot 110, are also contemplated.

The ladder 16 shown in FIG. 2 is an extension ladder, however other types of ladders, such as non-extension ladders, folding ladders, or A-frame ladders may also be used with swing anchor assembly 100. The extension ladder 16 is described in more detail, as a non-limiting example, to illustrate the principals of operation for swing anchor assembly 100. Ladder 16 comprises a first portion 24 and a second portion 26, each extending with 2 parallel legs 17 (as best shown in FIG. 6) in the direction of a ladder long axis 25. The parallel legs 17 of each of the first portion 24 and the second portion 26 of the ladder 16, are connected by a plurality of spaced apart rungs 28. The rungs 28 are generally evenly spaced along the length of the first portion 24 and second portion 26, and extend along a pivot axis 15, that is orthogonal to the ladder long axis 25. Thus, the rungs 28 connect between the legs 17 at approximately a 90-degree angle. As shown in FIG. 2, each of the rungs 28 are formed as a hollow tubular member and thus form a rung cavity 30 that extends between the legs 17 of the ladder 16.

As will be discussed in greater detail in reference to additional FIGs., the swing anchor assembly 100 mounts to the ladder 16 in pairs by using one of the rung cavities 30, and is thus positionable along the length of the ladder 16 at any rung 28 position. The ability to mount the swing anchor assembly 100 at any rung 28 position, provides flexibility to transport ladders 16 in variety of different lengths and to adjust and optimized the lengths of ladder 16 extending over the enclosed passenger cabin 2 and past the rear of the tailgate 12. In some situations, such as when passing into parking garages having limited overhead height, a user may choose to shift the ladder 16 more towards the rear of the cargo bed 4 to minimize the overall height of the ladder 16 passing above the passenger vehicle 10. In other situations, a user may instead prefer additional ground clearance between the end of the ladder 16 and the ground behind the passenger vehicle 10, and thus may choose to shift the ladder 16 more forward, towards the front of the cargo bed 4. In each selected transport position, the swing anchor assembly 100 is adjustable, and will adapt to any rung 28 position that proximately coincides with the tailgate 12. Similarly, the ability of the swing anchor assembly 100 to adapt to any rung 28 position allows for a variety of passenger vehicles 10, having longer or shorter cargo bed 4 lengths, to effectively and securely transport ladders 16.

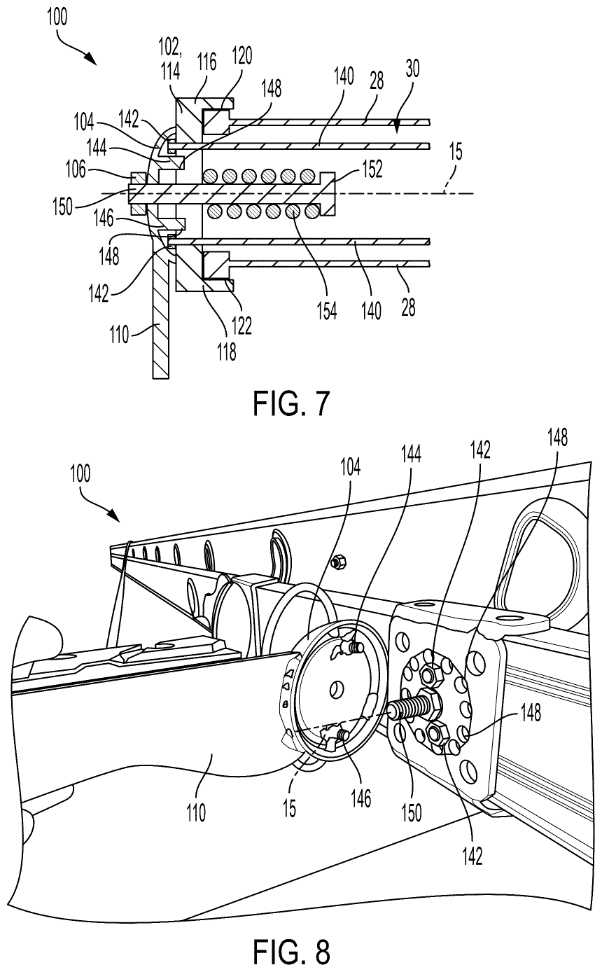

Referring to FIGS. 1 and 2, once a pair of swing anchor assemblies 100 have been positioned along the selected rung 28 of the ladder 16, they are secured together within the rung cavity 30, as is further discussed in reference to FIGS. 6 and 7 below. By connecting to the ladder 16 in this manner, no holes are drilled into the ladder 16, and thus the safety, safety rating, and strength of the ladder 16 are not impacted by the installation of swing anchor assembly 100. Once each of the swing anchor assemblies 100 are rigidly fixed into position, each of the swing anchor feet 110 are rotated outward from the ladder 16 and into engagement with the tailgate inner surface 14. When the ladder 16 is initially loaded onto the cargo bed 4, the ladder 16 weight establishes contact between the ladder 16 and one or both of the tailgate top surface 20 and the cabin surface 22. To further secure the ladder 16 into position for transport, one or more straps 18 connect to the cargo bed 4 and apply a force to pull the ladder 16 into additional frictional engagement with the tailgate top surface 20 and the cabin surface 22. Depending on the angle of the forces applied by straps 18, the tension on straps 18 may also pull the swing anchor feet 110 into additional frictional engagement with the tailgate inner surface 14.

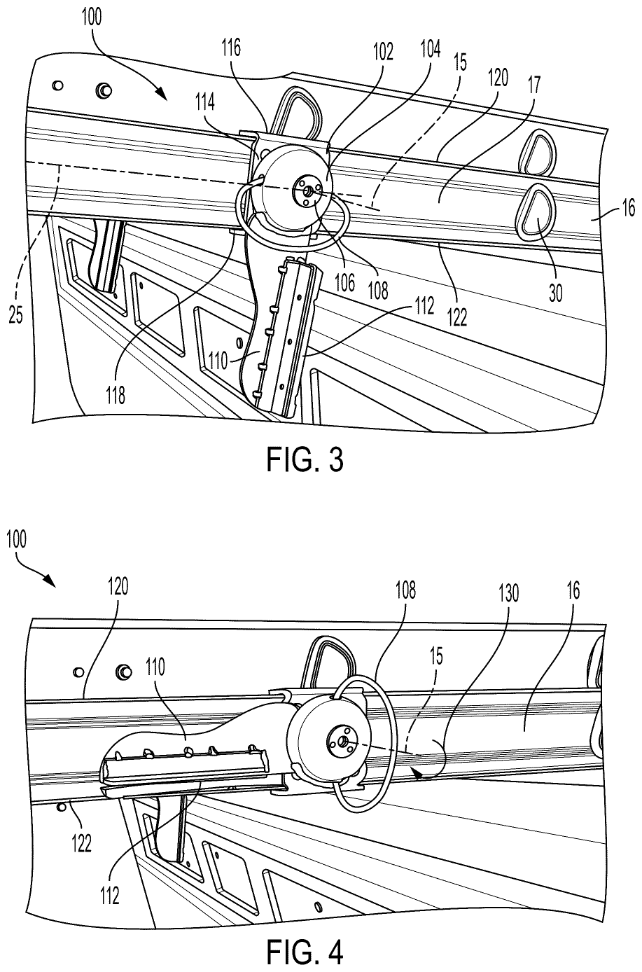

Referring to FIG. 3, swing anchor assembly 100 of FIG. 2 is again shown to discuss various externally visible components of swing anchor assembly 100. As shown, the swing anchor assembly 100 comprises a slidable base 102, a housing 104, a nut 106, a handle 108, a swing anchor foot 110, and a pad 112. The slidable base 102 comprises a web portion 114 that lays in a plane that is oriented generally orthogonal to the pivot axis 15 and parallel to the ladder long axis 25. In addition, the slidable base 102 further comprises a first flange 116 and a second flange 118 extending outward from the web portion 114 in the direction of the pivot axis 15. When viewed inline with the ladder long axis 25, the slidable base 102 generally forms a “C-channel” shape as also shown in the partial cross-sectional view of FIG. 7. By forming a C-channel shape, the slidable base 102 is able to slide over and capture three edges of the ladder 16. In particular, when the swing anchor assembly 100 is installed on the ladder 16, the web portion 114 lays adjacent to and generally parallel with the leg 17, the first flange 116 lays adjacent to and generally parallel with a ladder inner surface 120, and the second flange 118 lays adjacent to and generally parallel with a ladder outer surface 122. The C-channel shape of the slidable base 102 is advantageous from a strength perspective given that the first flange 116 and second flange 118 are spaced apart from the neutral bending axis of the ladder 16 (generally shown as the ladder long axis 25) and apart from the neutral bending and torsional axis of the swing anchor assembly 100 (generally shown as the pivot axis 15), when forces are applied through the swing anchor foot 110 during the transport of ladders 16. In addition, the C-channel shape of the slidable base 102 is advantageous from an ease-of-use perspective, when the swing anchor assembly 100 is being installed on the ladder 16 or is being moved from one rung 28 position on the ladder 16 to a second rung 28 position. In particular, when the ladder 16 is positioned horizontally or inclined by less than 45-degrees, relative to horizontal, as shown in FIG. 3, the C-channel shape will hold a first swing anchor assembly 100 in position proximate to a rung cavity 30, while a second swing anchor assembly 100 is positioned along the other side of the rung cavity 30, and while the first and second swing anchor assemblies 100 are connected together.

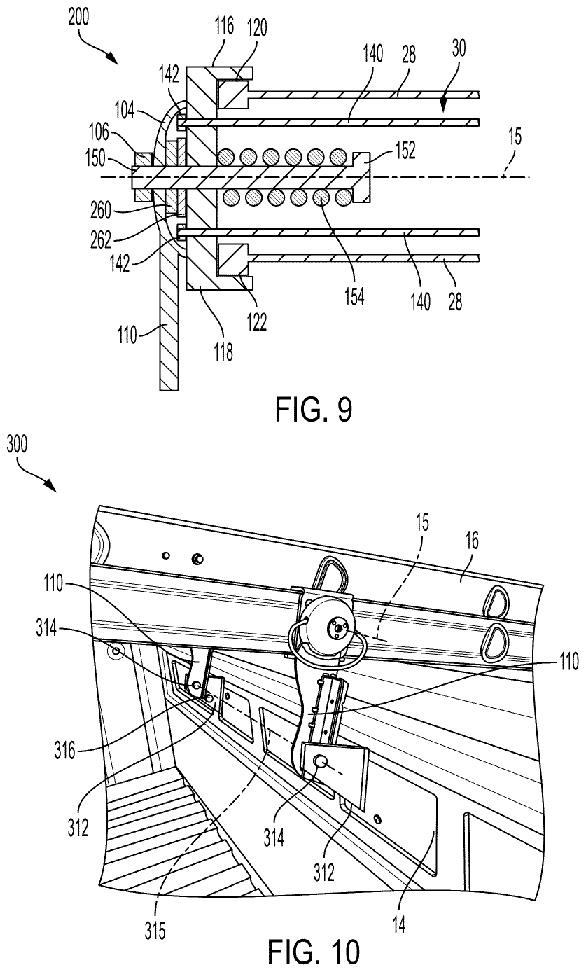

Once the first and second swing anchor assemblies 100 are connected, via connections passing within the rung cavity 30, as described with reference to FIGS. 6 and 7 below, the slidable bases 102 of each of the first and second swing anchor assemblies 100 are generally held in a fixed position relative to the legs 17 of the ladder 16. The swing anchor foot 110 is then pivotally attached to the slidable base 102, as described with reference to FIGS. 8 and 9 below, such that the swing anchor foot 110 is selectively rotatable along the pivot axis 15. To select a rotated position, handle 108 may be pulled outward along the pivot axis 15, thereby pulling outward on the housing 104, both of which are attached to the swing anchor foot 110. With a tension force is applied to the handle 108, the housing 104 translates outwards along pivot axis 15 away from the stationary slidable base 102, and the swing anchor foot 110 can be rotated into the desired angular position along pivot axis 15. When the tension force is released from the handle 108, the housing 104 translates along the pivot axis 15 towards the stationary slidable base 102, and the swing anchor foot 110 is locked into a stationary angular position relative to the ladder 16 and the stationary slidable base 102. Once the swing anchor foot 110 is in the desired position, the handle 108 may be rotated out of position, in either direction relative to the swing anchor foot 110, so that it lays generally flat relative to the web portion 114.

In the embodiment shown in FIG. 3, the handle 108 is formed in a “C-shape” to provide able room for a user's hand while also maintaining clearance around the generally hemi-spherical shaped housing 104. In addition, the handle 108 is formed from spring steel, to allow for elastic rather than plastic deformation, if the handle 108 is selectively removed from the housing 104. Removing the handle 108 may be desirable during the transport of ladders 16 to prevent other objects within the cargo bed 4 from catching on the handle 108 and inadvertently changing the selected angular position of the swing anchor foot 110. Similarly, the hemi-spherical shaped housing 104 may also be desirable for maintaining the selected angular position of the swing anchor foot 110, because the hemi-spherical shape will resist tension forces from being applied outward along the pivot axis 15, by other objects within the cargo bed 4.

Referring to FIGS. 4 and 5, the swing anchor assembly 100 is shown in the “inoperable or retracted mode”, whereby the swing anchor foot 110 is rotated along the pivot axis 15 along a first direction 130 (as shown in FIG. 4) or along a second direction 132 (as shown in FIG. 5) such that swing anchor foot 110 is generally in-line with the ladder long axis 25. In the embodiment shown in both FIGS. 4 and 5, the dimensions of the swing anchor foot 110 were chosen so that the swing anchor foot 100 did not extend past the ladder inner surface 120 or the ladder outer surface 122, when viewed along the pivot axis 15. By not extending past either the ladder inner surface 120 or the ladder outer surface 122, the safety and functionality of the ladder 16 is maintained during the ladder's 16 climbing use. More specifically, in the “inoperable or retracted mode” shown in FIGS. 4 and 5, no trip hazards are introduced by portions of the swing anchor assembly 100 overhanging the step surfaces of the rungs 28.

Referring to FIGS. 6 and 7, swing anchor assembly 100 is shown to discuss additional components which were not externally visible in the prior FIGs. and to further discuss the principles of operation. FIG. 6 shows two swing anchor assemblies 100 coupled together, but decoupled from the ladder 16, while and FIG. 7 shows a partial cross-sectional view, along the pivot axis 15, of a swing anchor assembly 100 installed on ladder 16.

As previously discussed, a pair of swing anchor assemblies 100 may be used together and secured to one another at any rung 28 position. As best shown in FIG. 6, one method to secure the swing anchor assemblies 100 together is with the use of one or more tie rods 140 that extend between the swing anchor assemblies 100 within the rung 28. As shown in FIG. 7, the tie rods 140 pass between the web portions 114 via thru holes and are secured by nuts 142. As the nuts 142 are tightened, the two swing anchor assemblies 100 are compressed against the legs 17 of the ladder 16, and the swing anchor assemblies 100 are held in a fixed position relative to the rungs 28. By connecting to the ladder 16 in this manner, no holes are drilled into the ladder 16, and thus the safety, safety rating, and strength of the ladder 16 are not impacted by the installation of swing anchor assembly 100. One having ordinary skill in the art will recognize that instead of using two swing anchor assemblies 100, one swing anchor assembly 100 could instead be used and a cover plate (not shown) could be used in place of the omitted swing anchor assemblies 100.

As previously discussed, the angular position of the swing anchor foot 110 is selectably adjustable along the pivot axis 15 relative to the stationary position of the slidable base 102, when a tension force is applied to the handle 108, and the housing 104 translates outwards along pivot axis 15 away from the stationary slidable base 102. Additionally, the swing anchor foot 110 is held rotationally stationary relative to the slidable base 102 when the handle 108 is released and the housing 104 translates inwards along pivot axis 15 towards the stationary slidable base 102. FIGS. 6 and 7 illustrate one embodiment that enables this performance. As shown in both FIG. 7, the swing anchor foot 110 further includes a pin 144 and a pin 146 which are mounted within the housing 104. When the housing 104 is pulled away from the slidable base 102, the pins 144, 146 are not coupled to the slidable base 102, and the swing anchor foot 110 is free to rotate about the pivot axis 15. However, when the housing 104 is not pulled away from the slidable base 102, the pins 144, 146 engage with one or more holes or detents 148, that are arranged circumferentially around the pivot axis 15 and within the web portion 114 of the slidable base 102, and the swing anchor foot 110 becomes locking into a fixed angular position relative to the slidable base 102. To enable rotation of the swing anchor foot 110 about the pivot axis 15, a post 150 extends through the slidable base 102 and the housing 104 where it is secured into position by nut 106. The post 150 further comprises a head 152 that captures a spring 154 concentrically mounted on the post 150 and along the pivot axis 15. The spring 154 is compressively loaded as the nut 106 is tightened onto the post 150, and the compressive force biases the pins 144, 146 into engagement with the one or more holes or detents 148. In this manner, the swing anchor foot 110 is in “normally locked” condition when no external forces are applied to the handle 108 (FIGS. 2-4) to translate the pins 144,146 out of engagement with the one or more holes or detents 148. FIG. 8. shows a view of the swing anchor assembly 100 having the nut 106 and housing 104 removed to expose the pins 144, 146 and holes or detents 148.

Referring to FIG. 9, another swing anchor assembly 200 is shown that is similar in operation to swing anchor assembly 100 previously described, so the same reference numbers are used for similar components, and the description below will focus on features of swing anchor assembly 200 that are different from swing anchor assembly 100. In particular, swing anchor assembly 200 omits the pins 144, 146 and detents 148 and instead uses a pair of face contacting washers 260, 262 to restrict rotational movement of the swing anchor foot 110 along the pivot axis 15. Washers 260, 262 are concentrically positioned along the pivot axis 15. Washer 260 is rotationally fixed to housing 104, while washer 262 is rotationally fixed to the web portion 114 of the slidable base 102. The abutting faces of washers 260, 262 are pressed into engagement by the spring 154 and mating splines (not shown) or friction between the abutting faces of the washers 260, 262 then restrict rotation of the swing anchor foot 110.

Referring to FIG. 10 another swing anchor assembly 300 is shown that is similar in operation to swing anchor assembly 100 previously described, so the same reference numbers are used for similar components, and the description below will focus on features of swing anchor assembly 300 that are different from swing anchor assembly 100. In particular, the swing anchor foot 110 further comprising a pivot shoe 312 that is configured to contact the tailgate inner surface 14, wherein the pivot shoe 312 is rotatable relative to the swing anchor foot 110 along a pin 314 and a shoe pivot axis 315 that is offset from and parallel to the pivot axis 15. In some embodiments, the pivot shoe 312 is freely rotating along the shoe pivot axis 315 and the angular resting position of the pivot shoe 312 is determined by the contact angle with the tailgate inner surface 14. On other embodiments, the angular rotation of the pivot shoe 312 is restricted to bounds (e.g., plus or minus 15-degrees) and such angular motion restriction is achieved by one or more stops 316 protruding from the pivot shoe 312 and contacting adjacent portions of the swing anchor foot 110 when the bounds of the allowed angular motion are achieved. In still other embodiments, the pivot shoe 312 is rotationally lockable along the shoe pivot axis 315 using methods similar to those described for locking the rotational motion of the swing anchor foot 110 along the pivot axis 15.

In addition to the embodiments described above, many examples of specific combinations are within the scope of the disclosure, some of which are detailed below:

One or more specific embodiments of the present disclosure have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A system for transporting a ladder on a truck, the truck including a tailgate top surface, a tailgate inner surface, a cargo bed, and a cabin surface positioned higher than the tailgate top surface, and a strap, the system comprising:
a first swing anchor foot configured to pivotally attach to the ladder and to rotate relative to the ladder into a plurality of lockable positions and into engagement with the tailgate inner surface, and configured such that a force applied by the strap pulls the ladder into frictional engagement with the tailgate top surface and the cabin surface.

2. The system of claim 1 wherein the first swing anchor foot is further configured such that the force applied by the strap also pulls the first swing anchor foot into frictional engagement with the tailgate inner surface.

3. The system of claim 1 further comprising a second swing anchor foot that is pivotally attached to the ladder and is configured such that rotation of the second swing anchor foot relative to the ladder will bring the second swing anchor foot into frictional engagement with the tailgate inner surface, and wherein the second swing anchor foot is rotatable and lockable independent of the first swing anchor foot.

4. The system of claim 3 wherein the first swing anchor foot and the second swing anchor foot are configured to rotate along a pivot axis that passes through a rung cavity of the ladder.

5. The system of claim 4 further comprising a first slidable base and a second slidable base which are bolted together by a tie rod that passes through the rung cavity of the ladder, wherein the first slidable base and second slidable base are selectably positionable along a plurality of locations along the ladder.

6. The system of claim 5 wherein the first swing anchor foot further comprising a pivot shoe that is configured to contact the tailgate inner surface, wherein the pivot shoe is rotatable relative to the first swing anchor foot along a shoe pivot axis that is offset from and parallel to the pivot axis.

7. The system of claim 6, wherein the pivot shoe is rotationally lockable along the shoe pivot axis.

8. The system of claim 5 wherein the first swing anchor foot further comprises a pin and the first slidable base further comprises a plurality of detents arranged circumferentially around the pivot axis, wherein the first swing anchor foot is configured to rotate along the pivot axis and lock into a fixed angular position relative to the first slidable base when the pin engages with one of the plurality of detents.

9. The system of claim 8 further comprising:
a spring concentrically mounted on a post and along the pivot axis and configured to be positioned within the rung cavity of the ladder when the first slidable base and the second slidable base are bolted together, and wherein compression from the spring acts to maintain engagement between the pin and one of the plurality of detents.

10. The system of claim 5 wherein the first swing anchor foot further comprises a first washer and the first slidable base further comprises a second washer concentrically positioned along the pivot axis, wherein the first swing anchor foot is configured to rotate along the pivot axis and lock into a fixed angular position relative to the first slidable base when the first washer engages with the second washer.

11. A method for transporting a ladder, the method comprising:
placing the ladder along a tailgate top surface and a cabin surface positioned higher than the tailgate top surface;
attaching a swing anchor assembly to the ladder, wherein the swing anchor assembly has a first swing anchor foot;
rotating the first swing anchor foot relative to the ladder and into engagement with the tailgate inner surface;
locking the first swing anchor foot rotated position; and
applying a force with a strap to secure the ladder against the tailgate top surface and the cabin surface.

12. The method of claim 11, wherein applying the force with the strap also pulls the first swing anchor foot into frictional engagement with the tailgate inner surface.

13. The method of claim 11, wherein the first swing anchor foot further comprising a pivot shoe, that is rotatable relative to the first swing anchor foot along a shoe pivot axis that is offset from and parallel to the pivot axis, the method further comprising rotating the first swing anchor foot into engagement with the tailgate inner surface.

14. The method of claim 11, wherein the swing anchor assembly further comprises a second swing anchor foot, the method further comprising:
rotating the second swing anchor foot relative to the ladder and into engagement with the tailgate inner surface; and
locking the second swing anchor foot rotated position.

15. The method of claim 14, wherein the rotating of the first swing anchor foot and the second swing anchor foot occurs along a pivot axis that passes through a rung cavity of the ladder, and wherein the attaching of the swing anchor assembly to the ladder comprises:
passing a tie rod through the rung cavity of the ladder; and
tightening the tie rod to secure a first slidable base and a second slidable base to the ladder.

16. The method of claim 15, wherein the rotating of the first swing anchor foot moves a pin relative to the pivot axis and wherein the locking of the first swing anchor foot comprises engaging the pin with one of a plurality of detents on the first slidable base.

17. The method of claim 16, wherein the swing anchor assembly further comprises a spring concentrically mounted on a post and along the pivot axis, and wherein the attaching of the swing anchor assembly includes positioning the spring and the post within the rung cavity of the ladder, and wherein the locking of the first swing anchor foot includes the spring compressively engaging the pin into one of the plurality of detents.

18. A ladder comprising a system for transporting the ladder on a truck, the truck including a tailgate top surface, a tailgate inner surface, a cargo bed, and a cabin surface positioned higher than the tailgate top surface, and a strap, the system comprising:
a first swing anchor foot configured to pivotally attach to the ladder and to rotate relative to the ladder into a plurality of lockable positions and into engagement with the tailgate inner surface, and configured such that a force applied by the strap pulls the ladder into frictional engagement with the tailgate top surface and the cabin surface.

19. The ladder of claim 18, further comprising a second swing anchor foot that is pivotally attached to the ladder and is configured such that rotation of the second swing anchor foot relative to the ladder will bring the second swing anchor foot into frictional engagement with the tailgate inner surface, and wherein the second swing anchor foot is rotatable and lockable independent of the first swing anchor foot.

20. The ladder of claim 19, wherein the first swing anchor foot and second swing anchor foot are configured to rotate along a pivot axis that passes through a rung cavity of the ladder.
